(19) United States
(12) Patent Application Publication
(10) Pub. No.: US 2004/0189797 A1
(43) Pub. Date: Sep. 30, 2004

(54) Console lid family entertainment system

(76) Inventors: Neal Jonathan Todd, Chesterfield, MI (US); Stephen Wayne Hoffman, Riverview, MI (US); Christopher E. Andrews, South Lyon, MI (US); Brian Reece Howell, Lake Orion, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/403,251

(22) Filed: Mar. 31, 2003

(51) Int. Cl. H04N 7/18

(52) U.S. Cl. 348/61; 348/148

(57) ABSTRACT

A family entertainment video system for a motor vehicle integrated within a console unit comprises a console housing lid that is hingedly attached to a console base at a base end and defines a first space. The console housing lid includes a base plate and a cover plate hingedly attached at one lid end, wherein the base plate and the cover plate define a second space when in a closed configuration. A multimedia device is mounted to the base plate in the second space for providing a multimedia program signal. A video screen module is hingedly attached to the base plate for swinging out from the second space to a viewable position and for swinging back from the viewing position to a stowed position. The video screen module receives the multimedia program signal from the multimedia device and displays the video content of the output signal to a viewable area.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

The present invention relates in general to a vehicle family entertainment system and, more specifically, to a vehicle video system concealed within a center console lid.

2. Description of the Related Art

Family entertainment video systems typically comprise a video monitor, a video player such as a DVD player or similar media source device along with any associated electronics routing the signal from the player to the video monitor. In many instances the video player or similar media source device is remote from the video monitor. Because automotive vehicles vary in size and content, packaging locations will vary depending upon the available space needed for packaging such devices. In vehicles where common packaging locations cannot be utilized, unique or vehicle specific mounting structures are needed to accommodate a system or a specific device.

The video screen is routinely mounted in a central viewing location such as a headliner of the interior compartment of the vehicle directly behind the front passenger seats or in the headrests of a passenger seat directly in front of a passenger. The video player may either be mounted in the front console along with other multimedia devices or in close proximity to the video screen. This requires separate packaging locations to accommodate the video player and the video monitor resulting in additional cost such as tooling expenses to accommodate unique packaging locations between various vehicle platforms. Also, a wire harness for providing a power supply and/or an audio connections must be unique for each vehicle where the video monitor and video player packaging locations vary.

### SUMMARY OF THE INVENTION

Consonant with the present invention, a family entertainment video system for a vehicle contains a video player and a video monitor located within a center console lid which is common among a plurality of vehicles and is similarly located among a plurality of vehicle interiors and is interchangeable among a plurality of vehicle interiors.

The family entertainment video system for a motor vehicle integrated within a console unit comprises a console housing lid that is hingedly attached to a console base at a base end and defines a first space. The console housing lid includes a base plate and a cover plate hingedly attached at one lid end, wherein the base plate and the cover plate define a second space when in a closed configuration. A multimedia device is mounted to the base plate in the second space for providing a multimedia program signal. A video screen module is hingedly attached to the base plate for swinging out from the second space to a viewable position when the cover plate is in an open configuration and for swinging back from the viewing position to a stowed position when the cover plate is in a closed position. The video screen module receives the multimedia program signal from the multimedia device and displays the video content of the output signal to a viewable area within a vehicle when the video screen module is in said viewable position.

### BRIEF DESCRIPTION OF THE DRAWINGS

FIG. 1 is a view of an interior compartment of a vehicle showing a console lid entertainment system on a center console base.

FIG. 2a is a console lid entertainment system showing a first hinged system in a closed configuration.

FIG. 2b is a console lid entertainment system showing a second hinged system in an open configuration.

FIG. 3a is a console lid system in a viewing position according to a first embodiment.

FIG. 3b is a console lid system in a stowed position according to a first embodiment.

FIG. 4 is a console lid system including an adjustable rail system according to a second embodiment.

FIG. 5 is a console lid system including a docking port system according to a second embodiment.

### DETAILED DESCRIPTION OF PREFERRED EMBODIMENTS

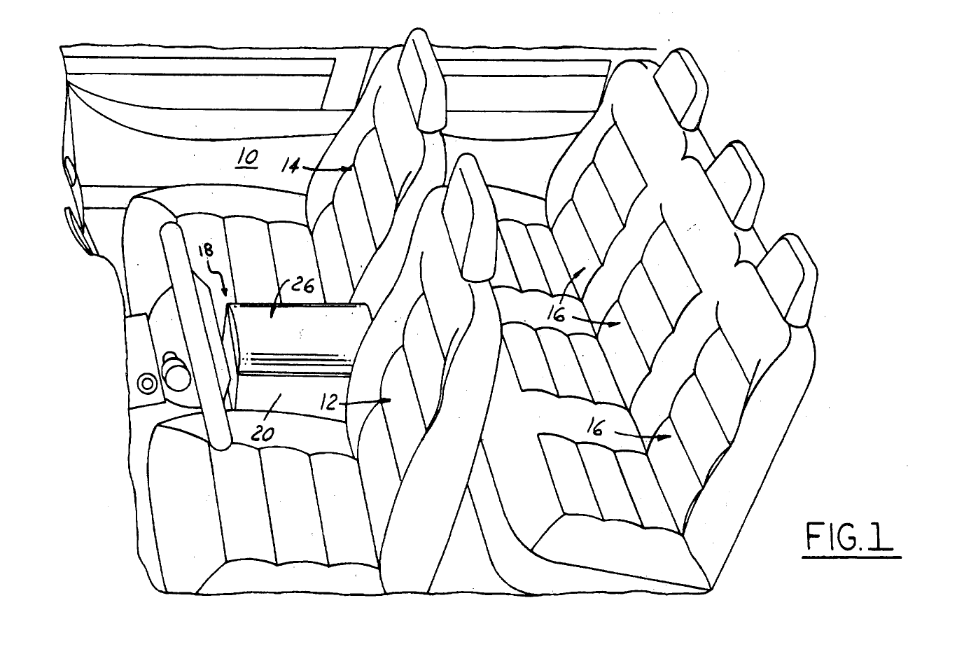

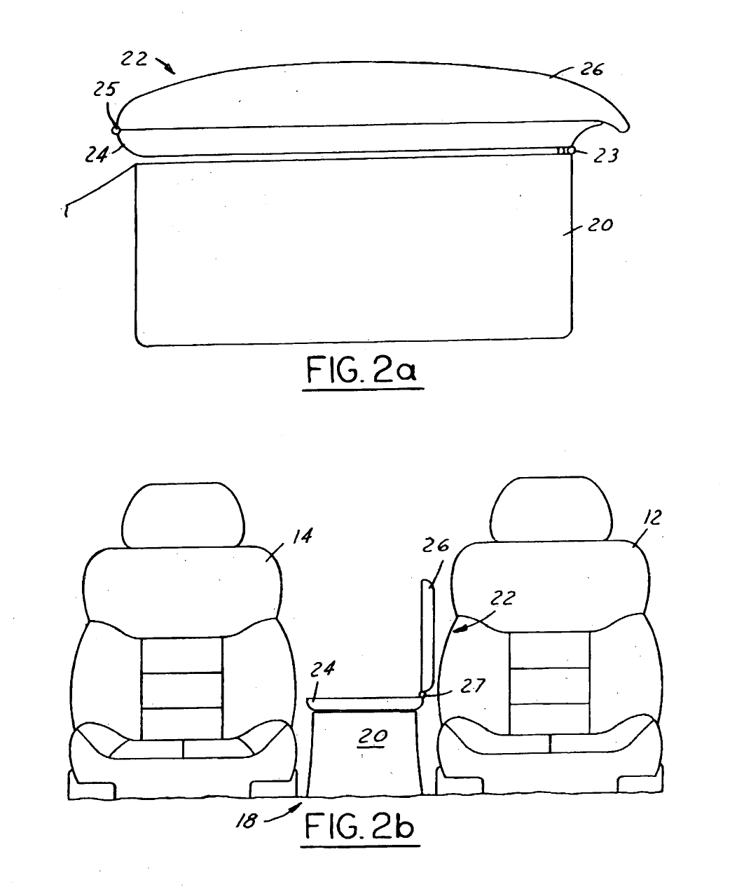

Referring now to the Drawings and particularly to FIG. 1, there is shown an interior passenger compartment 10 of a vehicle according to the present invention. The interior passenger compartment 10 comprises a front drivers seat 12, a front passenger seat 14, a rear passenger seats 16, and a center console 18. The center console 18 is located between the front driver seat 12 and the front passenger seat 14 and forward of the rear passenger seats 16. The center console 18 contains a console base 20 and a console housing lid 22. The console housing lid 22 is attached to the console base 20 by a base hinge system 23 (shown in FIG. 2a) at one end of the base console 20 and forms a first space or compartment when in a closed configuration. This allows passengers of a vehicle to access and store items within the compartment such as CD's, DVDs, and other personal items. A driver or a front seat passenger may also use the console housing lid 22 as an arm rest.

FIG. 2a illustrates a preferred embodiment of the console housing lid 22 in a closed configuration. The console housing lid 22 includes a base plate 24 forming a bottom surface of the console housing lid 22. A cover plate 26 is attached by a first hinge system 25 to one end of the base plate 24 and forms a second space when in a closed configuration. The first hinge system 25 contains two attachment plates rotating about an axis. Alternatively, other types of hinged or pivoting systems known in the art can be used. A first attaching plate is fixed to the cover plate 26 while the second attaching plate is fixed to the base plate 24. The first hinge system 25 is located at a distal end of the cover plate 26 toward a forward end of the vehicle. When the console lid is rotated to an open configuration, contents of the second space will be accessible to occupants seated in the font passenger seats or the rear passenger seats 16.

FIG. 2b illustrates an alternative hinged system. A second hinged system 27 is located on an end of the console housing lid 22 adjacent to either the front driver seat 12 or the front passenger seat 14. In this embodiment, the cover plate 26 is pivoted in a direction of a front passenger seat 14 to form an open configuration.

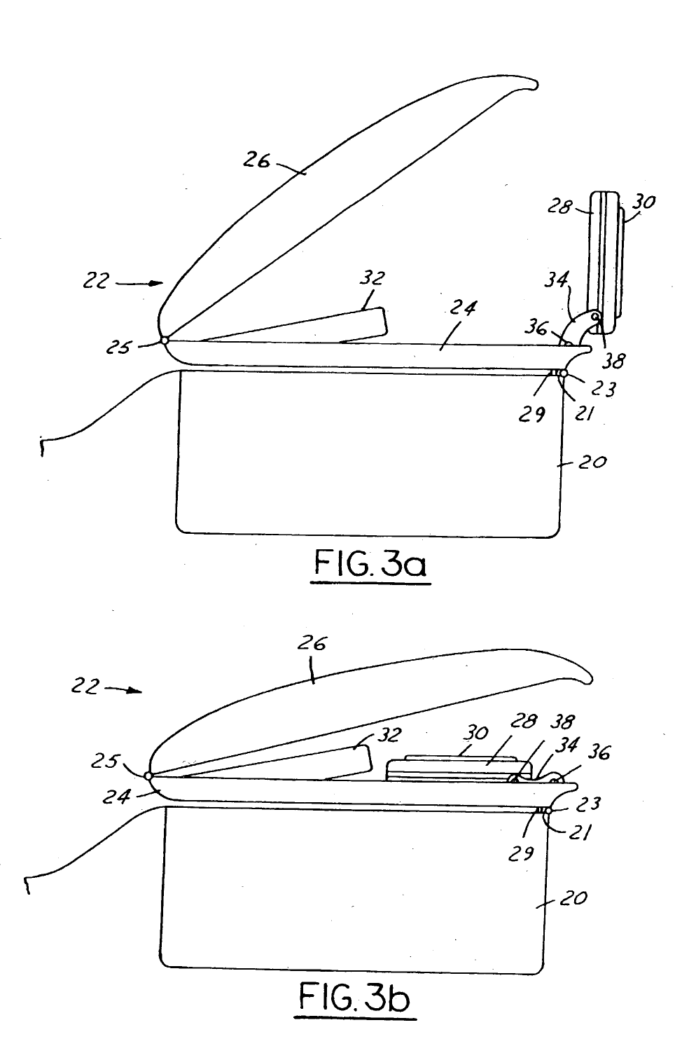

FIG. 3a illustrates a preferred embodiment of the console housing lid 22 integrating a vehicle video system. The video screen module 28 includes a video screen 30 for displaying a video content of a multimedia program. The video screen module 28 is moveable into a viewing position for displaying a video content of a multimedia program to the occupants of a vehicle in a viewing area and a stowed position when the video screen module is not in use. The video screen module 28 is attached to the base plate 24 by a second hinged system including a curved mounting arm 34 having a first end mounted to the base plate 24 at a first pivot pin 36. The second end of the curved mounting arm 34 is mounted to the video screen module at a second pivot pin 38.

When in the viewing position, the cover plate 22 is in an open configuration. The video screen module 28 is rotated about the first pivot pin 36 up and away from the base plate 24 and toward the occupants of the rear passenger seats 16 until a positive stop is reached. The video screen 30 will be facing the occupants of the rear passenger seats 16 so that the video content of a multimedia program is displayed to the viewing area. The video screen module 28 is rotatable about the second pivot pin 38 so that the occupants may achieve an optimum viewing angle. Other embodiments of hinged or pivoting systems known in the art that can be utilized including but not limited to include rotating hinges, extending hinges, extension rails, articulating arms, or any other system that pivots or extends to a viewing position.

FIG. 3b illustrates the video screen module 28 in a stowed position occupying the second space with the console lid 22 itself. When in the stowed position, the video screen module 28 and curved mounting arm 34 are rotated about the first pivot pin 36 away from the rear seat passengers until the video screen module 28 and is lying parallel to the base plate 24 and are encased in the second space of the console housing lid 22.

A multimedia device 32 such as a DVD player is located adjacent to the video screen module 28 in the second space. Alternatively, the multimedia device 32 can be a video player, a video game, a hard drive, a media player, or an MP3 player. The multimedia device 32 is mounted on the base plate 24 and is preferably positioned so that a front face of the multimedia device 32 is tilted upward. Tilting the front face of multimedia device 32 allows a sufficient amount of clearance for a multimedia source such as a DVD disc to be inserted without any obstruction from the video screen module 28. Fasteners used to mount the multimedia device 32 to the base plate 24 can include bolts, screws, studs, clips, hooks or any other fastener used for attachment. Additionally, various mounting locations (e.g. holes) may be incorporated onto the base plate 24 to accommodate the multimedia device 32 having different dimensions.

A power-feed line 21 located at an end of the of the console lid 22 supplies power and ground to the multimedia device 32 and the video screen module 28. The power-feed line 21 is routed on a same end as the base hinge system 23 and extends from the console base 20 through the base plate 24 of the console lid 22 to the multimedia device 32 and video screen module 28. An audio feed 29 using a hardwire line is also routed on a same end as the base hinge system 23 and extends from the console base 20 through the base plate 24 to the multimedia device 32. Alternatively, the audio feed 29 can use a communication bus (such as a CAN, J1850, LAN, etc.) or can be transmitted wirelessly to receiver units located throughout the vehicle.

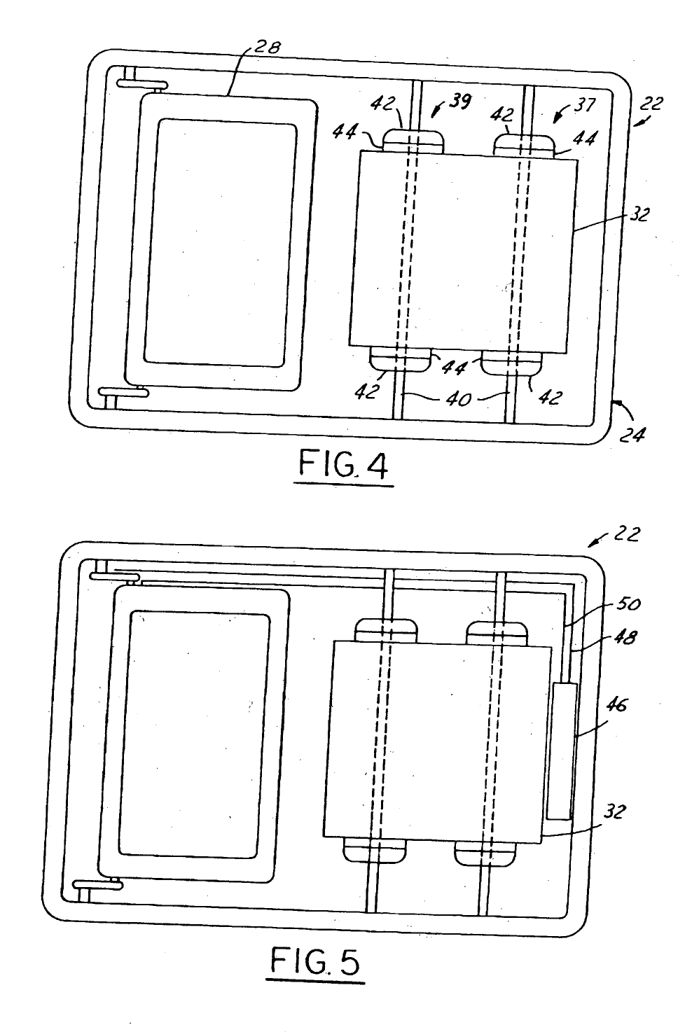

FIG. 4 illustrates a second preferred embodiment of the console housing lid including an adjustable rail system 39. The adjustable rail system 39 allows a plurality of multimedia devices of different dimensions to be inserted into the console housing lid 22. The adjustable rail system 39 includes a plurality of rails 40 extending a width of the base plate 24. The plurality of rails 40 are fastened to the base plate at each end of the plurality of rails 40. A pair of clamping fixtures 42 is slideable along the plurality of rails 40 so as to adjust to the width of a particular multimedia device. The pair of clamping fixtures 42 applies pressure to each side of the particular multimedia device so that the particular multimedia device is in compression with the clamping fixture 42. The clamping fixtures 42 are locked in place once the particular multimedia device is in compression with the clamping fixtures 42 so as to avoid movement by the particular multimedia device. A pad 44 may be attached to each of the pair of clamping fixtures 42 to avoid damage to the plurality of multimedia devices.

FIG. 5 illustrates a third preferred embodiment of a console housing lid including a docking port system. A docking port 46 is located in the console housing lid 22 and is mounted to the base plate 24 for receiving a video signal and an audio signal from the multimedia device 32. The docking port 46 has a video output 48 connected to the video screen module 28 and an audio output 50 connected to receiving units located throughout the vehicle. Alternatively, the docking port can be mounted on a second adjustable rail system so as to adjust and align to a video and an audio outputs of the multimedia device. Another embodiment of FIG. 5 includes a wireless transmission system wherein the docking port 46 receives the audio and video signal from the multimedia device 32 and provides a wireless video signal and audio signal to the video screen module 28 and the receiving units located within the vehicle.

From the foregoing description, one ordinarily skilled in the art can easily ascertain the essential characteristics of this invention and, without departing from the spirit and scope thereof, can make various changes and modifications to the invention to adapt it to various usages and conditions. For example, a rear console base with a rear console housing lid can accommodate a vehicle console lid entertainment system. Furthermore, vehicles having a console lid with outer structure of a set dimension are interchangeable among a plurality of vehicles having an outer structure of the same set dimension.

What is claimed is:

1. An integrated console video system for a motor vehicle comprising:
a console housing lid for hingedly attaching to a console base at one base end and enclosing a first space, said console housing lid including a base plate and a cover plate hingedly attached at one lid end, said base plate and said cover plate enclosing a second space when in a closed configuration;
a multimedia device mounted to said base plate in said second space for providing a multimedia program signal;
a video screen module hingedly mounted to said base plate for swinging out from said second space at a second lid end to a viewable position when said cover plate is in an open configuration and for swinging back from said viewing position to a stowed position when said cover plate is in a closed position; and
wherein said video screen module receives said multimedia program signal of said multimedia device and displays video content of said output signal to a viewable area within a vehicle when said video screen module is in said viewable position.

2. The integrated console video system of claim 1 wherein said base plate includes an adjustable rail structure for attaching said video screen module and said multimedia device of various dimensions wherein said adjustable rail structure is adaptable to a plurality of console housing lids of various dimension.

3. The integrated console video system of claim 2 herein said multimedia device is removable from adjustable rail structure and said adjustable rail structure accommodates a plurality of multimedia devices.

4. The integrated console video system of claim 3 further comprising a docking port for coupling said multimedia device to said video screen module.

5. The integrated console video system of claim 4 wherein said docking port is a wireless communication port.

6. The integrated console video system of claim 1 wherein said console base is a center console unit.

7. The integrated console video system of claim 1 further comprising a power-feed, said power-feed linked to said console housing lid at said one base end for supplying power to said multimedia device and said video screen module.

8. The integrated console video system of claim 1 further comprising an audio channel for providing an audio signal of said multimedia device to receiving units located throughout said vehicle.

9. The integrated console video system of claim 8 wherein said audio channel is an audio bus that passes through said console base at said one base end where said console housing lid is hingedly attached to said console base, whereby said audio bus provides said audio signal to said receiving units.

10. The integrated console video system of claim 1 wherein said audio channel is a wireless transmitter for providing said audio signal to said receiving units.

11. The integrated console video system of claim 1 wherein said multimedia device is a video player.

12. The integrated console video system of claim 1 wherein said multimedia device is a DVD player.

13. The integrated console video system of claim 1 wherein said multimedia device is a video game station.

14. The integrated console video system of claim 1 wherein said multimedia device is a hard drive.

15. An integrated vehicle video system for a motor vehicle comprising:
a console housing lid hingedly attached to a console base at one base end and enclosing a first space, said console housing lid including a base plate and a cover plate hingedly attached at one lid end, said base plate and said cover plate enclosing a second space when in a closed configuration;
a multimedia device mounted to said base plate in said second space for providing a multimedia program signal;
a video screen module hingedly mounted to said base plate for swinging out from said second space at a second lid end to a viewable position when said cover plate is in an open configuration and for swinging back from said viewing position to a stowed position when said cover plate is in a closed position;
an audio channel for outputting an audio signal of said multimedia device and a receiving unit located in said vehicle for receiving said audio signal;
a power-feed linked to said console housing lid at said one base end for supplying power to said multimedia device and said video screen module; and
wherein said video screen module receives said multimedia program signal of said multimedia device and displays video content of said output signal to a viewable area within a vehicle when said video screen module is in said viewable position.

16. The integrated vehicle video system of claim 1 wherein said console housing lid having an outer structure of a set dimension is interchangeable among a plurality of vehicles containing a second console base that is adapted to attach a second console housing lid having a said outer structure of same said set dimension.
